(19) United States
(12) Patent Application Publication
(10) Pub. No.: US 2018/0223063 A1
(43) Pub. Date: Aug. 9, 2018

(54) STABLE STYRENIC FOAM WITH METAL OXIDE INFRARED ATTENUATOR

(71) Applicant: Dow Global Technologies LLC, Midland, MI (US)

(72) Inventors: Van-Chau Vo, Wollerau (CH); Inken Beulich, Waedenswil (CH)

(73) Assignee: Dow Global Technologies LLC, Midland, MI (US)

(21) Appl. No.: 15/109,899

(22) PCT Filed: Jan. 27, 2015
(86) PCT No.: PCT/US2015/012976

§ 371 Date: Jul. 6, 2016

Related U.S. Application Data
(60) Provisional application No. 61/934,869, filed on Feb. 3, 2014.

(51) Int. Cl. C08J 9/00; C08J 9/228

(52) U.S. Cl. CPC C08J 9/0066; C08J 9/228; C08J 2201/03; C08J 2309/06; C08J 2203/14; C08J 2203/12; C08J 2203/20; C08J 2203/06

(57) ABSTRACT

Polymer foam contains a continuous matrix of styrenic polymer that has metal oxide particulates selected from a group consisting of alumina boehmite and magnesium oxide and brominate styrene/butadiene copolymer dispersed therein.

### BACKGROUND OF THE INVENTION

### Field of the Invention

The present invention relates to styrenic polymer foam containing a metal oxide infrared attenuator selected from a group consisting of alumina boehmite and magnesium oxide and a process for preparing such foam.

### Introduction

Polymer foam, such as styrenic polymer foam, is commonplace as a thermally insulating material in the building industry as well as in other applications. In order to meet building fire performance code requirements, thermally insulating polymer foam typically requires a flame retardant. Perhaps the most commonly used flame retardant in polymer foam is hexabromocyclododecane (HBCD). However, other flame retardants such as brominated styrene/butadiene copolymer materials are becoming known in the polymer foam art. In many ways, brominated styrene/butadiene copolymer materials are more desirable than HBCD for use as a flame retardant. For instance, the copolymer materials are less likely to migrate from polymer foam than smaller molecule HBCD.

Infrared attenuating agents are also desirable in thermally insulating foam. Infrared attenuating agents inhibit infrared radiation from penetrating through polymer foam containing the infrared attenuating agent. Examples of infrared attenuating agents include carbon black, graphite, and metal oxides such as alumina boehmite and magnesium oxide.

An occasional problem with using brominated flame retardants in polymer foam is that the flame retardant can degrade during processing. Degradation of the flame retardant is undesirable. Degradation of flame retardant during processing reduces the amount of flame retardant remaining in the foam to protect the foam from burning. Additionally, degradation of a brominated flame retardant during foam processing can produce free bromide in the processing formulation, which can combine with moisture to form a corrosive acid that can damage processing equipment. To inhibit degradation of the flame retardant, stabilizers are often included in a polymer foam formulation. Yet, it would reduce the complexity of the foam processing method if stabilizers were not necessary.

It is desirable, therefore, to develop polymer foam that contains brominated styrene/butadiene copolymer flame retardant, an infrared attenuating agent and that is stable to flame retardant decomposition so as to minimize any need to including a separate stabilizer material.

### BRIEF SUMMARY OF THE INVENTION

The present invention is a result of discovering a surprising synergistic effect between brominated styrene/butadiene copolymer flame retardants and metal oxide infrared attenuators selected from a group consisting of alumina boehmite and magnesium oxide, the effect being inherent stability of the flame retardant to degradation.

The data in the Example section reveal that brominated styrene/butadiene copolymer inherently has the same or even lower stability to free bromide formation than HBCD during foam processing. Nonetheless, metal oxide infrared attenuators selected from a group consisting of alumina boehmite and magnesium oxide in combination with the brominated flame retardants in a foam formulation result in significantly less free bromide with brominated styrene/butadiene copolymer than with HBCD. Therefore, the metal oxide surprisingly selectively stabilizes the brominated styrene/butadiene copolymer flame retardant against degradation. In essence, the present invention involves a discovery that metal oxides selected from a group consisting of alumina boehmite and magnesium oxide can be used as a stabilizer for brominated styrene/butadiene copolymer in polymer foam as well as serve as an infrared attenuator.

Hence, the solution to the problem is surprisingly obtained by preparing polymer foam using a brominated styrene/butadiene copolymer flame retardant and a metal oxide infrared attenuating agent selected from a group consisting of alumina boehmite and magnesium oxide.

In a first aspect, the present invention is polymer foam comprising a continuous matrix of styrenic polymer having brominated styrene/butadiene copolymer and metal oxide particulates selected from a group consisting of alumina boehmite and magnesium oxide dispersed within that continuous matrix of styrenic polymer.

In a second aspect, the present invention is a process for preparing the comprising: (a) providing a foamable polymer composition comprising a styrenic polymer, metal oxide particulates selected from a group consisting of alumina boehmite and magnesium oxide, brominated styrene/butadiene copolymer and a blowing agent; (b) allowing the foamable polymer composition to expand into the polymer foam of the first aspect.

The process of the present invention is useful for preparing the foam of the present invention. The foam of the present invention is useful as thermal insulating material.

### DETAILED DESCRIPTION OF THE INVENTION

Test methods refer to the most recent test method as of the priority date of this document unless a date is indicated with the test method number. References to test methods contain both a reference to the testing society and the test method number. Test method organizations are referenced by one of the following abbreviations: ASTM refers to ASTM International (formerly known as American Society for Testing and Materials); EN refers to European Norm; DIN refers to Deutsches Institute für Normung; and ISO refers to International Organization for Standards.

“And/or” means “and, or as an alternative”. “Multiple” means two or more. All ranges include endpoints unless otherwise indicated.

Polymer foam comprises a polymer matrix that forms a cellular structure. That is, the polymer matrix is a continuous network of polymer that defines multiple cells within the polymer matrix.

Polymer foam of the present invention comprises a continuous matrix of styrenic polymers. Suitable styrenic polymers include styrene homopolymers and styrene copolymers, including block and random copolymers. Particularly desirable styrene copolymers include styrene-acrylonitrile (SAN) copolymers, especially SAN block copolymers. Typically, the styrenic polymer is non-halogenated. The styrenic polymer of the continuous matrix typically accounts for 50 weight-percent (wt %) or more, preferably 60 wt % or more, 70 wt % or more, 80 wt % or more and can account for 90 wt % or more, and even 95 wt % or more of the total weight of polymer foam.

The polymer foam of the present invention comprises metal oxide particulates selected from a group consisting of alumina boehmite and magnesium oxide dispersed within the continuous matrix of styrenic polymer. The metal oxide particulates serve as infrared attenuators, which means they inhibit transmission of infrared radiation through the polymer foam.

The metal oxide particulates desirably have an average particle size of 20 nanometers (nm) or larger and can be 100 nm or larger, 500 nm or larger, one micrometer or larger, even 10 micrometers or larger. At the same time it is desirable for the metal oxide particulates to have an average particle size of 100 micrometers or smaller, and they can have an average particle size of 50 micrometers or smaller, 10 micrometers or smaller, one micrometer or smaller, 500 nm or smaller and even 200 nm or smaller. Determine average particle size by laser diffraction particle size analysis according to ASTM B822-10.

The concentration of metal oxide particulates selected from a group consisting of aluminum boehmite and magnesium oxide dispersed within the continuous matrix of styrenic polymer is desirably 0.3 wt % or more, preferably 0.5 wt % or more, one wt % or more, three wt % or more, four wt % or more, five wt % or more, ten wt % or more, 15 wt % or more and can be 20 wt % or more and even 25 wt % or more. At the same time, it is typical for the concentration of metal oxide particulates to be 30 wt % or less, preferably 25 wt % or less, 20 wt % or less, 15 wt % or less or even ten wt % or less. Determine wt % metal oxide particulates relative to total polymer foam weight.

The polymer foam of the present invention further comprises brominated styrene/butadiene (S/B) copolymer dispersed within the continuous matrix of styrenic polymer. The brominated S/B copolymer is in addition to the styrenic polymer described for the continuous matrix of styrenic polymer. The brominated S/B copolymer serves as a fire retardant for the polymer foam. Desirably, the brominated S/B copolymer is as described in U.S. Pat. No. 7,851,558 (incorporated herein by reference).

The brominated S/B copolymer is desirably a copolymer having polymerized therein a butadiene moiety and a styrene moiety where the styrene monomer content, prior to bromination, is in a range of 5 to 90 wt % based on copolymer weight.

At the same time, it is desirable for the brominated S/B copolymer, prior to bromination, to have a weight average molecular weight of at least 1000 and 200,000 or less as determined by gel permeation chromatography relative to a polybutadiene standard.

At the same time, it is desirable for the brominated S/B copolymer, prior to bromination, to have a non-brominated, non-aromatic double bond content of less than or equal to 15 percent based upon non-aromatic double bond content of the copolymer prior to bromination as determined by proton nuclear magnetic resonance spectroscopy.

At the same time, it is also desirable for the brominated S/B copolymer to have a 1,2-butadiene isomer content of greater than zero wt %, preferably ten wt % or more, still more preferably 15 wt % or more, even more preferably 20 wt % or more and can be 25 wt % or more, 30 wt % or more, 50 wt % or more, 60 wt % or more, 70 wt % or more, 80 wt % or more and even 90 wt % or more and at the same time is generally less than 100 wt % based upon butadiene moiety weight.

At the same time, it is desirably for the brominated S/B copolymer to have a five percent weight loss temperature as determined by thermogravimetric analysis of at least 200 degrees Celsius (° C.), preferably 205° C. or higher, still more preferably 210° C. or higher, even more preferably 215° C. or higher, yet more preferably 220° C. or higher ore 225° C. or higher.

At the same time, it is desirable for the brominated S/B copolymer to be a block copolymer, preferably a styrene-butadiene-styrene block copolymer with a block of butadiene polymer between blocks of styrene polymer.

Typically, the S/B copolymer is present at a concentration of 0.5 wt % or more, preferably one wt % or more, more preferably two wt % or more, still more preferably three wt % or more and can be four wt % or more, five wt % or more seven wt % or more, ten wt % or more and even fifteen wt % or more while at the same time is typically 25 wt % or less, more typically 20 wt % or less and can be 15 wt % or less and even ten wt % or less relative to the total weigh to of the polymer foam.

Surprisingly, the metal oxide synergistically serves as a stabilizer for the brominated S/B copolymer. This is particularly surprising in view of the data below in the Examples section that indicates the metal oxides do not have a similar effect with hexabromocyclododecane (HBCD). It is even more surprising in view of the data in the Examples section indicating that the brominated S/B copolymer is less stable than HBCD in the absence of the metal oxide. The synergistic effect between the brominated S/B copolymer and the metal oxide is apparent because polymer foam containing brominated S/B copolymer and a metal oxide has a free bromide concentration lower than similar polymer foam that is free of the metal oxide particulates. A “similar polymer foam” is identical in composition as to polymer foam to which it is similar except for those components cited (for example, metal oxide particulates).

Determine stability of a brominated flame retardant such as brominated S/B copolymer or HBCD by determining the concentration of free bromide in the polymer foam. Brominated flame retardants can degrade during foam formation and in the process release free bromide. The more free bromide in the polymer foam the less stable the brominated flame retardant. In contrast, the less free bromide in the polymer foam the more stable the brominated flame retardant.

Determine the free bromide content in polymer foam according to the following two-step process.

First dissolve two grams of polymer foam in 20 milliliters (mLs) of dichloromethane and then add 20 mLs of deionized water. Mix the resulting solution for 30 minutes. Centrifuge the resulting solution at 2000 revolutions per minute for five minutes and isolate the aqueous phase by membrane filtration using a 0.45 micrometer filter.

Second, analyze the aqueous phase by photometry using the chloramine-T-Phenol-Red spectrometric method. Prepare two stock solutions. The first stock solution is an acetate buffer solution containing phenol Red (14.4 milligrams in 500 mL acetate/acetic acid solution). The second stock solution is 120 milligrams of Chloramine-T dissolved in 100 mL deionized water. Dilute the aqueous phase from the first step in water to a 10:1 concentration and take six mL of the diluted aqueous phase and mix with five mL of the acetate stock solution. Then add two mL of the second stock solution and mix for a 3.5 minutes. After mixing, add one mL of a 2.5 wt % aqueous solution of sodium thiosulfate. The bromide reacts with the chloramines-T-phenol-red causing the solution to become blue, a solution called “bromophenol blue solution”. Add the bromophenol blue solution to a 10 millimeter square quartz cell of an ultraviolet (UV)/visible (VIS) spectrophotometer. The absorption of 590 nm wavelength light is measured using a bland reference sample of deionized water. The UV/VIS spectrophotometer is a UV-2401 spectrophotometer (Shimadzu). Quantification of the absorption is done using the Lambert-Beers law which describes the linear correlation between absorbance and concentration of absorbing material. Calibrate using potassium bromide reference solutions. The precision of the method for determining free bromide concentration is approximately 2 parts per million and the method is capable of measuring free bromide concentration in a range of approximately 0.2 parts per million to 1000 parts per million. Concentrations of free bromide are in weight parts per million weight parts of polymer.

Desirably, polymer foam of the present invention has a free bromide concentration of 30 milligrams or less, preferably 25 milligrams or less, more preferably 20 milligrams or less and still more preferably 15 milligrams or less and can be ten milligrams or less per kilogram of polymer foam.

The polymer foam can contain or be free of one or more than one additional infrared attenuators other than metal oxides selected from a group consisting of alumina boehmite and magnesium oxide dispersed within the continuous styrenic polymer matrix of the foam. For example, the polymer foam can contain or be free from an additional infrared attenuator selected from a group consisting of carbon black and graphite. The additional infrared attenuator is typically present at a concentration of ten wt % or less, preferably five wt % or less and usually three wt % or less, two wt % or less, one wt % or less or 0.75 wt % or less or even 0.5 wt % or less based on total polymer foam weight.

The polymer foam of the present invention is made by the process of the present invention. The process of the present invention includes: (a) providing a foamable polymer composition comprising a styrenic polymer, metal oxide particulates selected from a group consisting of alumina boehmite and magnesium oxide, brominated styrene/butadiene copolymer and a blowing agent; and (b) allowing the foamable polymer composition to expand into the polymer foam of the present invention.

The styrenic polymer, metal oxide particulates and brominated styrene/butadiene copolymer are as described above for the polymer foam.

Suitable blowing agents include any of those suitable for preparing polymer foam. Examples of suitable blowing agents include one or any combination of more than one selected from a group consisting of inorganic gases such as carbon dioxide, argon, nitrogen, and air; organic blowing agents such as water, aliphatic and cyclic hydrocarbons having from one to nine carbons including methane, ethane, propane, n-butane, isobutane, n-pentane, isopentane, neopentane, cyclobutane, and cyclopentane; fully and partially halogenated aliphatic hydrocarbons having from one to five carbons, preferably that are chlorine-free (e.g., difluoromethane (HFC-32), perfluoromethane, ethyl fluoride (HFC-161), 1,1,-difluoroethane (HFC-152a), 1,1,1-trifluoroethane (HFC-143a), 1,1,2,2-tetrafluoroethane (HFC-134), 1,1,1,2 tetrafluoroethane (HFC-134a), pentafluoroethane (HFC-125), perfluoroethane, 2,2-difluoropropane (HFC-272fb), 1,1,1-trifluoropropane (HFC-263fb), 1,1,1,2,3,3,3-heptafluoropropane (HFC-227ea), 1,1,1,3,3-pentafluoropropane (HFC-245fa), and 1,1,1,3,3-pentafluorobutane (HFC-365mfc)); fluorinated olefins; aliphatic alcohols having from one to five carbons such as methanol, ethanol, n-propanol, and isopropanol; carbonyl containing compounds such as acetone, 2-butanone, and acetaldehyde; ether containing compounds such as dimethyl ether, diethyl ether, methyl ethyl ether; carboxylate compounds such as methyl formate, methyl acetate, ethyl acetate;

carboxylic acid and chemical blowing agents such as azodicarbonamide, azodiisobutyronitrile, benzenesulfo-hydrazide, 4,4-oxybenzene sulfonyl semi-carbazide, p-toluene sulfonyl semi-carbazide, barium azodicarboxylate, N,N′-dimethyl-N,N′-dinitrosoterephthalamide, trihydrazino triazine and sodium bicarbonate.

The process for preparing the polymer foam can be any known in the art including extrusion foaming process and expanded bead foaming process.

In an expanded bead foam process, prepare a foamable polymer composition by incorporating a blowing agent into granules of polymer composition (for example, imbibing granules of polymer composition with a blowing agent under pressure). Subsequently, expand the granules in a mold to obtain a foam composition comprising a multitude of expanded foam beads (granules) that adhere to one another to form a “bead foam”. Pre-expansion of the independent beads is also possible followed by a secondary expansion within a mold. As yet another alternative, expand the beads apart from a mold and then fuse them together thermally or with an adhesive within a mold.

Bead foam has a characteristic continuous network of polymer bead skins that encapsulate collections of foam cells within the foam. Polymer bead skins have a higher density than cell walls within the bead skins. The polymer bead skins extend in multiple directions and connect any foam surface to an opposing foam surface, and generally interconnect all foam surfaces. The polymer bead skins are residual skins from each foam bead that expanded to form the foam. The bead skins coalesce together to form a foam structure comprising multiple expanded foam beads. Bead foams tend to be more friable than extruded foam because they can fracture along the bead skin network. Moreover, the bead skin network provides a continuous thermal short from any one side of the foam to an opposing side, which is undesirable in a thermal insulating material.

Polymeric foam articles of the present invention are desirably extruded polymer foam articles. Extruded polymer foam articles are made using an extrusion foam process.

An extrusion foam process comprises providing a foamable polymer composition in an extruder and then expelling the foamable polymer composition into a lower pressure environment through a foaming die to initiate expansion of the foamable polymer composition into a thermoplastic polymer foam. The extrusion process can be continuous or semi-continuous (for example, accumulative extrusion). In a general extrusion process, prepare a foamable polymer composition of a thermoplastic polymer with a blowing agent in an extruder by heating a thermoplastic polymer composition to soften it, mixing a blowing agent composition together with the softened thermoplastic polymer composition at a mixing temperature and pressure that precludes expansion of the blowing agent to any meaningful extent (preferably, that precludes any blowing agent expansion) and then expelling the foamable polymer composition through a die into an environment having a temperature and pressure below the mixing temperature and pressure. Upon expelling the foamable polymer composition into the lower pressure the blowing agent expands the thermoplastic polymer into a thermoplastic polymer foam. Desirably, cool the foamable polymer composition after mixing and prior to expelling it through the die. In a continuous process, expel the foamable polymer composition at an essentially constant rate into the lower pressure to enable essentially continuous foaming.

Accumulative extrusion is a semi-continuous process that comprises: 1) mixing a thermoplastic material and a blowing agent composition to form a foamable polymer composition; 2) extruding the foamable polymer composition into a holding zone maintained at a temperature and pressure which does not allow the foamable polymer composition to foam; the holding zone having a die defining an orifice opening into a zone of lower pressure at which the foamable polymer composition foams and an openable gate closing the die orifice; 3) periodically opening the gate while substantially concurrently applying mechanical pressure by means of a movable ram on the foamable polymer composition to eject it from the holding zone through the die orifice into the zone of lower pressure, and 4) allowing the ejected foamable polymer composition to expand to form the foam. U.S. Pat. No. 4,323,528, herein incorporated by reference, discloses such a process in a context of making polyolefin foams, yet which is readily adaptable to aromatic polymer foam.

Coalesced foam processes are also suitable embodiments of the present extrusion process. U.S. Pat. No. 3,573,152 and U.S. Pat. No. 4,824,720 (the teachings of both are incorporated herein by reference) contain descriptions of coalesced foam processes. In general, during a coalesced foam process a foamable polymer composition extrudes through a die containing multiple orifices oriented such that when the foamable polymer composition expands upon extrusion the resulting strands of foaming polymer contact one another and partially coalesce together. The resulting foam (“strand foam”) is a composition of foam strands extending in the extrusion direction of the foam. A skin typically defines each strand in the coalesced foam. While coalesced foam processes are suitable, the process can be free of forming independent foam strands and then subsequently fusing the strands together to form a stand foam.

Extruded polymeric foam articles are distinct from expanded polymer bead foam articles by being free from encapsulated collections of beads. While a strand foam has a skin similar to bead foam, the skin of a strand foam does not fully encapsulate groups of cells but rather forms a tube extending only in the extrusion direction of the foam. Therefore, the polymer skin in strand foam does not extend in all directions and interconnect any foam surface to an opposing surface like polymer skin in expanded polymer bead foam.

### EXAMPLES

Prepare Comparative Examples (Comp Exs) and Examples (Exs) as follows.

Flame Retardants

The flame retardants used in the following examples and comparative examples are hexabromocyclododecane (HBCD) and a brominated styrene/butadiene (S/B) copolymer. The brominated S/B copolymer contains 64 wt % bromine and has a 1,2 butadiene content of approximately 80% and a molecular weight of approximately 140,000 grams per mole (for example Emerald Innovation™ 3000, Emerald Innovation is a trademark of Chemtura Corporation).

The flame retardants are incorporated into the foaming process as polymer concentrates as described in Table 1 where values are presented in wt % relative to total weight of the concentrate. Araldite is a trademark of Huntsman Advanced Materials. Doverphos is a trademark of Dover Chemical Corporation. Plas-chek is a trademark of Ferro Corporation.

TABLE 1

| | | Brominated S/B |
|---|---|---|
| | HBCD | Copolymer |
| Component | concentrate | concentrate |
| Polystyrene (PS-680, 200,000 | 53.5 | 50.0 |
| gram per mole weight | | |
| average molecular weight) | | |
| Flame retardant | 33.5 | 37.0 |
| Epoxy novolac resin | 6.2 | 6.2 |
| (Araldite ™ ECN 1280) | | |
| Bis (2,4-dicumylphenyl) | 3.7 | 3.7 |
| pentaerythritol diphosphite | | |
| (Doverphos ™ S9228) | | |
| Epoxidized soybean oil | 3.1 | 3.1 |
| (Plas-chek ™ 775) | | |

Foam Process Follow the following extrusion foam process for the following examples and comparative examples.

Prepare a dry blend of 100 weight-parts (wt-pts) polystyrene resin, 0.1 wt-pts barium stearate, 0.2 wt-pts of 20 wt % copper phthalocyanine blue pigment in polystyrene, 0.2 wt-pts polyethylene, 0.2 wt-pts talc concentrate (concentrate is 50 wt % talc in polystyrene PS-680), flame retardant concentrate (if used), metal oxide (if used) and additional infrared attenuator (if used). The polystyrene resin is an 80/20 weight-ratio blend of low molecular weight polystyrene (weight average molecular weight (Mw) of 145,000 grams per mole and ratio of Mw to number average molecular weight (Mn) of 3.3) and a high molecular weight polystyrene (weight average molecular weight of 200,000 grams per mole and a Mw/Mn ratio of 2.7).

Feed the dry blend into an extrusion foam line with a 19 millimeter (0.75 inch) screw diameter with the melting temperature setting of 210 degrees Celsius (° C.). Feed at an extruder pressure of approximately 15 mega Pascals (MPa) into the molten dry blend 5.4 wt-pts of a blowing agent composition consisting of 66.6 wt % carbon dioxide, 27.8 wt % isobutane and 2.8 wt % ethanol and 2.8 wt % water to form a foamable polymer composition. Cool the foamable polymer composition to a temperature of approximately 125° C. and extrude through a slit die with a die gate opening having a width of 10 millimeters and height adjustable from 0.5 to two millimeters into atmospheric pressure (101 kiloPascals) and allow to expand into a polymeric foam board having a thickness of 10-15 millimeters and a width of 25-30 millimeters.

Characterize the resulting polymer foam by foam density according to ISO 845-95, cell size by microscope according to ASTM D-3576, and free bromide according to the two-step process described herein above.

### Comparative Examples A and B—No Metal Oxides

Prepare polymer foam with just the brominated flame retardant and without the metal oxide particulates. Specifics of the formulation (wt-pts relative to 100 wt-pts polystyrene resin), foaming process and the resulting roam characterization are in Table 2.

TABLE 2

| | |
|---|---|
| Comp | Comp |
| Ex A | Ex B |

Formulation

| | | |
|---|---|---|
| HBCD concentrate (wt-pts relative | 7.5 | 0 |
| to 100 wt-pts polystyrene resin) | | |
| Brominated S/B Copolymer concentrate | 0 | 8.1 |
| (wt-pts relative to 100 wt-pts polystyrene resin) | | |
| Concentration of Bromine | 1.86 | 1.86 |
| (wt-pts relative to 100 wt-pts foam) | | |

Process

| | | |
|---|---|---|
| Screw speed (revolutions per minute) | 83 | 83 |
| Extruder outlet pressure (mega Pascal) | 18 | 17 |
| Die Pressure (mega Pascal) | 7.7 | 6.6 |

Foam Characterization

| | | |
|---|---|---|
| Foam density | 41.6 | 42.4 |
| (kilograms per cubic meter (kg/m³)) | | |
| Cell Size (millimeters) | 0.34 | 0.31 |
| Free bromide concentration | 1 | 6 |
| (milligrams per kilogram foam) | | |

The data in Table 2 reveals that the brominated S/B copolymer produces more free bromide than HBCD in an absence of metal oxide.

### Comparative Examples C-E and Examples 1-3: Alumina Boehmite

Prepare polymer foam as described above with the additional formulation and process characteristics described in Tables 3 and 4. The Tables also describes resulting foam characteristics. Comp Ex C-E and Exs 1-3 include alumina boehmite, which is introduced into the foamable formulation during the dry blending step as a concentrate containing 25 wt % alumina boehmite in polystyrene. The alumina boehmite is a nanocrystalline inorganic material having a crystallite size of 20-200 nm in agglomerated form having agglomerate particle sizes of 15-45 microns as purchased from Sasol GmbH.

TABLE 3

| | | |
|---|---|---|
| Comp | Comp | Comp |
| Ex C | Ex D | Ex E |

Formulation

| | | | |
|---|---|---|---|
| HBCD concentrate (wt-pts relative | 7.5 | 7.5 | 7.5 |
| to 100 wt-pts polystyrene resin) | | | |
| Concentration of Bromine (wt-pts relative | 1.86 | 1.86 | 1.86 |
| to 100 wt-pts polystyrene resin) | | | |
| Alumina boehmite concentrate (wt-pts | 4.0 | 8.0 | 16.0 |
| relative to 100 wt-pts polystyrene resin) | | | |

Process

| | | | |
|---|---|---|---|
| Screw speed (revolutions per minute) | 83 | 79 | 78 |
| Extruder outlet pressure (mega Pascal) | 15.3 | 15.0 | 15.4 |
| Die Pressure (mega Pascal) | 5.5 | 5.1 | 5.2 |

Foam Characterization

| | | | |
|---|---|---|---|
| Foam density | 42.8 | 42.4 | 44.3 |
| (kilograms per cubic meter (kg/m³)) | | | |
| Cell Size (millimeters) | 0.35 | 0.20 | 0.21 |
| Free bromide concentration | 36 | 133 | 825 |
| (milligrams per kilogram foam) | | | |

TABLE 4

| | | |
|---|---|---|
| Ex 1 | Ex 2 | Ex 3 |

Formulation

| | | | |
|---|---|---|---|
| Brominated S/B Copolymer concentrate | 8.1 | 8.1 | 8.1 |
| (wt-pts relative to 100 wt-pts | | | |
| polystyrene resin) | | | |
| Concentration of Bromine (wt-pts relative | 1.86 | 1.86 | 1.86 |
| to 100 wt-pts polystyrene resin) | | | |
| Alumina boehmite concentrate (wt-pts | 4.0 | 8.0 | 16.0 |
| relative to 100 wt-pts polystyrene resin) | | | |

Process

| | | | |
|---|---|---|---|
| Screw speed (revolutions per minute) | 79 | 80 | 79 |
| Extruder outlet pressure (mega Pascal) | 17.1 | 15.6 | 16.0 |
| Die Pressure (mega Pascal) | 6.0 | 5.3 | 5.8 |

Foam Characterization

| | | | |
|---|---|---|---|
| Foam density | 44.1 | 44.5 | 46.3 |
| (kilograms per cubic meter (kg/m³)) | | | |
| Cell Size (millimeters) | 0.28 | 0.22 | 0.19 |
| Free bromide concentration | 10 | 12 | 37 |
| (milligrams per kilogram foam) | | | |

The data in Tables 3 and 4 reveals a synergistic stabilizing effect alumina boehmite has with brominated S/B copolymer that is not present with HBCD. Comparable paring of samples are Comp Ex C and Ex 1, Comp Ex D and Ex 2, and Comp Ex E and Ex 3. Each of those parings has the same level of initial bromine and alumina boehmite. Nonetheless, the resulting free bromide in the resulting polymer foam is dramatically different. The lower free bromide concentrations in Exs 1-3 reveal a more stable flame retardant against bromide release during foam processing. This is in view of the fact HBCD appears more stable to bromide loss than brominated S/B copolymer in an absence of the metal oxide (see Comp Ex A and B).

### Comparative Examples F-H and Examples 4-6: Magnesium Oxide

Prepare polymer foam as described above with the additional formulation and process characteristics described in Tables 5 and 6. The Tables also describes resulting foam characteristics. Comp Ex F-H and Exs 4-6 include magnesium oxide, which is introduced into the foamable formulation during the dry blending step as a concentrate containing 15 wt % magnesium oxide in polystyrene. The magnesium oxide has an average particle size of 0.5-20 micrometers as supplied by Konoshima or Martin Marietta Magnesia Specialties. Similar results are expected for magnesium oxide having an average particle size of 50-300 nm.

As with the alumina boehmite samples, the data in Tables 5 and 6 reveals a synergistic stabilizing effect magnesium oxide has with brominated S/B copolymer that is not present with HBCD. The lower free bromide concentrations in Exs 4-7 relative to comp Exs F-I reveal a more stable flame retardant against bromide release during foam processing. This is in view of the fact HBCD appears more stable to bromide loss than brominated S/B copolymer in an absence of the metal oxide (see Comp Ex A and B).

TABLE 5

| | | | |
|---|---|---|---|
| Comp | Comp | Comp | Comp |
| Ex F | Ex G | Ex H | Ex I |

Formulation

| | | | | |
|---|---|---|---|---|
| HBCD concentrate (wt-pts relative | 7.5 | 7.5 | 7.5 | 7.5 |
| to 100 wt-pts polystyrene resin) | | | | |
| Concentration of Bromine (wt-pts | 1.86 | 1.86 | 1.86 | 1.86 |
| relative to 100 wt-pts | | | | |
| polystyrene resin) | | | | |
| Magnesium oxide concentrate | 3.3 | 6.7 | 13.3 | 26.7 |
| (wt-pts relative to 100 wt-pts | | | | |
| polystyrene resin) | | | | |

Process

| | | | | |
|---|---|---|---|---|
| Screw speed | 85 | 85 | 83 | 83 |
| (revolutions per minute) | | | | |
| Extruder outlet pressure | 17.6 | 18.0 | 18.7 | 20.1 |
| (mega Pascal) | | | | |
| Die Pressure (mega Pascal) | 7.3 | 7.5 | 7.8 | 8.3 |

Foam Characterization

| | | | | |
|---|---|---|---|---|
| Foam density (kg/m³) | 45.1 | 46.2 | 46.7 | 48.9 |
| Cell Size (millimeters) | 0.25 | 0.23 | 0.2 | 0.19 |
| Free bromide concentration | 16 | 30 | 79 | 185 |
| (milligrams per kilogram foam) | | | | |

TABLE 6

| | | | |
|---|---|---|---|
| Ex 4 | Ex 5 | Ex 6 | Ex 7 |

Formulation

| | | | | |
|---|---|---|---|---|
| Brominated S/B copolymer | 8.1 | 8.1 | 8.1 | 8.1 |
| concentrate (wt-pts relative | | | | |
| to 100 wt-pts polystyrene resin) | | | | |
| Concentration of Bromine (wt-pts | 1.86 | 1.86 | 1.86 | 1.86 |
| relative to 100 wt-pts | | | | |
| polystyrene resin) | | | | |
| Magnesium oxide concentrate | 3.3 | 6.7 | 13.3 | 26.7 |
| (wt-pts relative to 100 wt-pts | | | | |
| polystyrene resin) | | | | |

Process

| | | | | |
|---|---|---|---|---|
| Screw speed | 82 | 82 | 81 | 81 |
| (revolutions per minute) | | | | |
| Extruder outlet pressure | 19.2 | 19.7 | 18.71 | 19.0 |
| (mega Pascal) | | | | |
| Die Pressure (mega Pascal) | 7.9 | 8.0 | 76.8 | 6.9 |

Foam Characterization

| | | | | |
|---|---|---|---|---|
| Foam density (kg/m³) | 46.1 | 45.9 | 47.7 | 50.2 |
| Cell Size (millimeters) | 0.27 | 0.26 | 0.28 | 0.19 |
| Free bromide concentration | 10 | 12 | 18 | 27 |
| (milligrams per kilogram foam) | | | | |

### Comp Exs J-K and Exs 8-11: Alumina Boehmite, Carbon Black and Graphite

For the following samples that include carbon black, include into the dry mix blend a carbon black concentrate containing 60 wt % carbon black (Thermax N990, a thermal black having an average particle size of 300 nanometers as supplied by Cancarb) in polystyrene, with wt % relative to total concentrate weight.

For the following samples that include graphite, include into the dry mix blend a graphite concentration containing 30 wt % graphite (Graphite UF-1 supplied by Kopfmuehl GmbH) dispersed in polystyrene, with wt % relative to total concentrate weight.

For Comp Exs J-K, repeat Comp Ex D but with two different loadings of the carbon black concentrate. For Examples 8 and 9, repeat Ex 2 but with two different loadings of the carbon black concentrate. For Examples 10 and 11, repeat Ex 2 but with two different loading of the graphite concentrate. The corresponding data is in Tables 7 and 8.

The data in Tables 7 and 8 reveals that even in the presence of carbon black or graphite the synergistic stabilizing effect of alumina boehmite on the brominated S/B copolymer is evident.

The data in Tables 7 and 8 reveals that even in the presence of carbon black or graphite the synergistic stabilizing effect of alumina boehmite on the brominated S/B copolymer is evident.

TABLE 7

| | |
|---|---|
| Comparative | Comparative |
| Example J | Example K |

Formulation

| | | |
|---|---|---|
| HBCD concentrate (wt-pts relative | 7.5 | 7.5 |
| to 100 wt-pts polystyrene resin) | | |
| Concentration of Bromine (wt-pts relative | 1.86 | 1.86 |
| to 100 wt-pts polystyrene resin) | | |
| Carbon Black concentrate (wt-pts relative | 0.8 | 8.0 |
| to 100 wt-pts polystyrene resin) | | |
| Alumina boehmite concentrate (wt-pts | 8.0 | 8.0 |
| relative to 100 wt-pts polystyrene resin) | | |

Process

| | | |
|---|---|---|
| Screw speed (revolutions per minute) | 77 | 73 |
| Extruder outlet pressure (mega Pascal) | 15.4 | 15.4 |
| Die Pressure (mega Pascal) | 5.1 | 5.1 |

Foam Characterization

| | | |
|---|---|---|
| Foam density | 43.7 | 45.8 |
| (kilograms per cubic meter (kg/m³)) | | |
| Cell Size (millimeters) | 0.21 | 0.17 |
| Free bromide concentration | 148 | 146 |
| (milligrams per kilogram foam) | | |

TABLE 8

| | | | |
|---|---|---|---|
| Ex 8 | Ex 9 | Ex 10 | Ex 11 |

Formulation

| | | | | |
|---|---|---|---|---|
| HBCD concentrate (wt-pts relative | 7.5 | 7.5 | 7.5 | 7.5 |
| to 100 wt-pts polystyrene resin) | | | | |
| Concentration of Bromine (wt-pts relative | 1.86 | 1.86 | 1.86 | 1.86 |
| to 100 wt-pts polystyrene resin) | | | | |
| Carbon Black concentrate (wt-pts relative | 0.8 | 8.0 | 0 | 0 |
| to 100 wt-pts polystyrene resin) | | | | |
| Graphite concentrate (wt-pts relative | 0 | 0 | 3.3 | 6.7 |
| to 100 wt-pts polystyrene resin) | | | | |
| Alumina boehmite concentrate (wt-pts | 8.0 | 8.0 | 8.0 | 8.0 |
| relative to 100 wt-pts polystyrene resin) | | | | |

Process

| | | | | |
|---|---|---|---|---|
| Screw speed (revolutions per minute) | 74 | 71 | 78 | 78 |
| Extruder outlet pressure (mega Pascal) | 16.2 | 15.3 | 18.2 | 18.5 |
| Die Pressure (mega Pascal) | 5.7 | 5.1 | 8.0 | 8.45 |

Foam Characterization

| | | | | |
|---|---|---|---|---|
| Foam density (kg/m³) | 44.5 | 48.7 | 43.2 | 44.5 |
| Cell Size (millimeters) | 0.19 | 0.16 | 0.14 | 0.14 |
| Free bromide concentration | 21 | 20 | 17 | 16 |
| (milligrams per kilogram foam) | | | | |

1. A polymer foam comprising a continuous matrix of styrenic polymer having brominated styrene/butadiene copolymer and metal oxide particulates selected from a group consisting of alumina boehmite and magnesium oxide dispersed within that continuous matrix of styrenic polymer.

2. (canceled)

3. (canceled)

4. The polymer foam of claim 1, further characterized by the styrenic polymer being selected from styrene homopolymer and copolymers of styrene and acrylonitrile.

5. The polymer foam of claim 1, further characterized by the polymer foam being more than 50 weight-percent styrenic polymer based on total polymer foam weight.

6. The polymer foam of claim 1, further characterized by the concentration of metal oxide particulates selected from a group consisting of alumina boehmite and magnesium oxide being 0.3 weight-percent or more and at the same time 20 weight-percent or less based on total polymer foam weight.

7. The polymer foam of claim 1, further characterized by the concentration of brominated styrene/butadiene copolymer being 0.5 weight-percent or more and at the same time 20 weight-percent or less based on total polymer foam weight.

8. The polymer foam of claim 1, further characterized by having an infrared attenuator selected from a group consisting of carbon black and graphite dispersed within the continuous matrix of styrenic polymer.

9. The polymer foam of claim 1, further characterized by having a free bromide content of less than 30 milligrams per kilogram of polymer foam.

10. A process for preparing the comprising: (a) providing a foamable polymer composition comprising a styrenic polymer, metal oxide particulates selected from a group consisting of alumina boehmite and magnesium oxide, brominated styrene/butadiene copolymer and a blowing agent; (b) allowing the foamable polymer composition to expand into the polymer foam of any previous claim.

11. The process of claim 10, further characterized by the process being an extrusion foaming process where the foamable polymer composition is extruded through a foaming die at an extrusion temperature and pressure and allowed to expand into the polymer foam in a region of lower pressure than the extrusion pressure and lower temperature than the extrusion temperature.
